(19) United States
(12) Patent Application Publication
(10) Pub. No.: US 2010/0219921 A1
(43) Pub. Date: Sep. 2, 2010

(54) RARE-EARTH IRON-BASED MAGNET WITH SELF-RECOVERABILITY

(75) Inventors: Fumitoshi YAMASHITA, Kitasaku-gun (JP); Osamu YAMADA, Kitasaku-gun (JP); Shiho OHYA, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-gun (JP)

(21) Appl. No.: 12/706,389

(22) Filed: Feb. 16, 2010

(30) Foreign Application Priority Data
Feb. 27, 2009 (JP) 2009-044970

(51) Int. Cl. H01F 7/02

(52) U.S. Cl. 335/302

(57) ABSTRACT

A rare-earth iron-based magnet with self-recoverability is provided and includes a plurality of segments, wherein the segments each include a matrix having a microstructure in which rare-earth iron-based aligned magnetic powders of at least one kind are solidified by a cross-linking reaction phase and also in which the cross-liking reaction phase and a viscous deformation phase resulting from on a viscosity flow are chemically bound to each other between the magnetic powders, and wherein while the inner and outer circumferential surfaces of the segments are constrained, the fracture surfaces of the segments, and also the segments on a needed-basis, are mutually aggregated and rigidified together by taking advantage of self-recovery function based on viscous deformation caused by heat and external force and also on cross-linking reaction.

### BACKGROUND OF THE INVENTION

1. Field of the Invention

The present invention relates to an anisotropic rare-earth iron boride/nitride-based magnet, and more particularly to a self-recoverable rare-earth iron-based magnet which is fabricated by taking advantage of a novel self-recoverability so as to have a continuously controlled anisotropy distribution and a (BH)ₘₐₓ of 160 kJ/m³ or more.

2. Description of the Related Art

Rare-earth iron-based hard magnetic materials, for example, Nd₂Fe₁₄B, αFe/Nd₂Fe₁₄B and Fe₃B/Nd₂Fe₁₄B which are obtained by rapid solidification such as melt spinning, are limited in form to a ribbon, or a flake obtained by milling. For this reason, in order to obtain a bulk magnet for use in a small motor, a technique is necessary by which the form of material is changed, specifically, the ribbon or the powder is solidified into a given bulk form in one way or another. A basic powder fixing means in powder metallurgy is pressureless sintering, but since magnetic properties based on a metastable state must be maintained in the abovementioned ribbon or flake, the pressureless sintering is hardly applicable to the solidification process. For this reason, the ribbon or the flake is consolidated into a specific form mostly by using a binder such as an epoxy resin.

For example, in 1985, R. W. Lee et al. reported that an isotropic Nd₂Fe₁₄B-based bonded magnet having a (BH)ₘₐₓ of 72 kJ/m³ is obtained when a ribbon having a (BH)ₘₐₓ of 111 kJ/m³ is solidified by means of a resin material (refer to Non-Patent Document 1).

In 1986, the present inventors et al. proved in Japanese Patent Application Laid-Open No. S61-38830 that an ring-shaped isotropic Nd₂Fe₁₄B magnet which is made of the above described ribbon solidified by using an epoxy resin and which has a (BH)ₘₐₓ of up to 72 kJ/m³ is suitable for use in a small motor. Further, for example, in 1990, G. X. Huang et al. clarified that an ring-shaped isotropic magnet is suitable for use in a small motor (refer to Non-Patent Document 2), and such a ring-shaped magnet has been widely used in the 1990's as a magnet for a high-performance small motor which is applied to an electromagnetic drive unit in electric and electronic equipment such as OA (office automation), AV (audio and visual), PC (personal computer), PC peripheral devices, and telecommunication equipment.

On the other hand, a lot of researches on the magnet material formed by a melt spinning method have been actively conducted since the 1980's, wherein an Nd₂Fe₁₄B- or Sm₂Fe₁₇N₃-based material, a nanocomposite material fabricated by taking advantage of an exchange coupling based on a microscopic texture between αFe, Fe₃B-based material and the foregoing material, and a material fabricated by fine-controlling a variety of alloy compositions and their texture are known, and also in addition to the materials described above, magnetic powders which are formed by a rapid solidification method other than the melt spinning and have a different powder shape are recently made available (refer to, for example, Non-Patent Documents 3 and 4). Also, Davies et al. reported an isotropic magnet which achieves a (BH)ₘₐₓ of as large as 220 kJ/m³ (refer to Non-Patent Document 5). However, it is supposed that a ribbon formed by the rapid solidification method and made industrially available has a (BH)ₘₐₓ of up to 134 kJ/m³ and that a ring-shaped isotropic magnet fabricated by using such a ribbon has a (BH)ₘₐₓ of about 80 kJ/m³.

Irrespective of the current technical condition described above, a relatively small electromagnetic drive unit to which the present invention relates is always requested to be further miniaturized and to perform with increased output and efficiency in response to the enhancement of the performance of electric and electronic equipment. Thus, it is obvious that just improving the magnetic properties of an isotropic ribbon formed by the rapid solidification method is no longer good enough for catching up with the enhancing performance of electric and electronic equipment. Therefore, it is increasingly required, especially in the field of a small electromagnetic drive unit, to provide a magnet which has a static magnetic field distribution adapted to a magnetic circuit with a core of the motor and at the same time which generates as strong static magnetic field as possible per unit volume.

Sm—Co-based magnetic powder for a rare-earth magnet, even when prepared by milling an ingot, achieves a high coercivity (HcJ). However, Co has problems in terms of securing a stable supply, its resource balance and so on, and therefore it is not appropriate to use Co generally as industrial material. On the other hand, rare-earth iron-based magnetic powder, which is composed mostly of Fe as well as a rare-earth element such as Nd, Pr, Sm or the like, is advantageous in view of a secured stable supply and a resource balance. Such rare-earth magnetic powder, however, achieves a low coercivity (HcJ) even if an ingot or sintered magnet of Nd₂Fe14B-based alloy is milled. For this reason, with regard to fabrication of anisotropic Nd₂Fe₁₄B magnetic powder, researches based on using a melt spinning material as starting material have been pursued in advance.

In 1989, Tokunaga obtained an anisotropic magnet with a (BH)ₘₐₓ of 127 kJ/m³ in such a manner that a bulk prepared by subjecting Nd₁₄Fe_{80-X}B₆Ga_{X} (X=0.4 to 0.5) to hot upsetting (die-upset) was milled and formed into anisotropic Nd₂Fe₁₄B magnetic powder which was then solidified by a resin material (refer to Non-Patent Document 6). Also, in 1991, H. Sakamoto et al. fabricated anisotropic Nd₂Fe₁₄B magnetic powder with a coercivity (HcJ) of L30 MA/m by subjecting Nd₁₄Fe_{79.8}B_{5.2}Cu₁ to hot rolling (refer to Non-Patent Document 7). As described above, the magnetic powder has been made available which achieves an increased coercivity (HcJ) in such a manner that the hot processing performance is improved with addition of Ga and Cu thereby further miniaturizing the Nd₂Fe₁₄B particle size. In 1991, V. Panchanathan et al. introduced an anisotropic magnet with a (BH)ₘₐₓ of 150 kJ/m³, which was fabricated by a hot mill method in such a manner that a bulk into which hydrogen was caused to make ingress from a grain boundary was collapsed as Nd₂Fe₁₄BH_{X} and dehydrogenated by vacuum heating into HD (hydrogen decrepitation)-Nd₂Fe₁₄B magnetic powder which was then solidified by a resin material (refer to Non-Patent Document 8). In 2001, by the same method described above, Iriyama formed Nd_{13.7}Fe_{7.35}Co_{6.7}B_{5.5}Ga_{0.6} into an anisotropic magnetic powder with a (BH)ₘₐₓ of 177 kJ/m³ which was then solidified by an epoxy resin binder and developed into an improved anisotropic magnet having a (MH)ₘₐₓ of 177 kJ/m³ (refer to Non-Patent Document 9).

Meanwhile, Takeshita et al. proposed an HDDR (hydrogenation-decomposition-desorption-recombination) method in which an Nd—Fe(Co)—B ingot is heat-treated in hydrogen atmosphere such that: Nd₂(Fe, Co)₁₄B phase is hydrogenated (hydrogenation, Nd₂(Fe, Co)₁₄BH_{X}); the phase is decomposed at 650 to 1000° C. (decomposition, NdH₂+Fe+Fe₂B); hydrogen is desorbed (desorption); and recombination is performed (recombination) (refer to Non-Patent Document 10). And, in 1999, an anisotropic magnet with a (BH)ₘₐₓ of 193 kJ/m³ was fabricated by solidifying HDDR Nd₂Fe₁₄B magnetic powder with an epoxy resin binder (refer to Non-Patent Document 11).

In 2001, Mishima et al. introduced Co-free d-HDDR Nd₂Fe₁₄B magnetic powder (refer to Non-Patent Document 12), and N. Hamada et al. fabricated a cubic anisotropic magnet (7 mm cubed) with a density of 6.51 Mg/m³ and a (BH)ₘₐₓ of 213 kJ/m³ in such a manner that d-HDDR Nd₂Fe₁₄B magnetic powder with a (BH)ₘₐₓ of 358 kJ/m³ was compacted together with an epoxy resin binder in the presence of an aligned magnetic field of 2.5 T under a pressure of 0.9 GPa at an elevated temperature of 150° C. (refer to Non-Patent Document 13).

However, such a cubic (or rectangular) magnet as described above is not suitable for an electromagnetic drive unit represented by many of motors to which the present invention relates. Especially, for application in an electromagnetic drive unit represented by a small motor having an output of several ten W or less, a ring-shaped magnet with a thickness of about 1 to 2 mm must be adapted to meet the design concept of the electromagnetic drive unit in terms of reducing diameter or thickness, making thickness uneven, increasing length, and the like. When a magnet is formed directly as a ring-shaped anisotropic magnet, if the ring diameter is reduced (or the length is increased), much of magnetomotive force in the radial magnetic field direction is dissipated as a leakage magnetic flux thus causing the oriented magnetic field to decrease. Consequently, the (BH)ₘₐₓ with respect to the radial direction decreases in accordance with reduction in diameter (or increase in length). As a result, for application in an electromagnetic drive unit, a small-diameter ring-shaped anisotropic magnet with one or more magnetic pole pairs has not been widely available as a next generation model after a ring-shaped isotropic magnet having a (BH)ₘₐₓ of about 80 kJ/m³.

Japanese Patent No. 2911017 discloses a magnet manufacturing method in which four arc-segments are combined to form a ring-shaped compact, and the compact is sintered under ordinary pressure.

On the other hand, D. Johnson et al. disclosed a “quasi-Halbach array” in which rectangular anisotropic sintered magnets are embedded at respective predetermined positions of a ring-shaped soft magnetic body, instead of a “Halbach array” in which a ring-shaped anisotropic magnet is composed of arc-segments (refer to Non-Patent Document 14).

<<Non-Patent Documents>>

<Non-Patent Document 1> R. W. Lee, E. G Brewer, N. A. Schaffel, “Hot-pressed Neodymium-Iron-Boron magnets” IEEE Trans. Magn., Vol. 21, 1958 (1985)
<Non-Patent Document 2> G. X. Huang, W. M. Gao, S. F. Yu, “Application of melt-spun Nd—Fe—B bonded magnet to the micro-motor”, Proc. of the 11th International Rare-Earth Magnets and Their Applications, Pittsburgh, USA, pp. 583-594 (1990)
<Non-Patent Document 3> B. H. Rabin, B. M. Ma, “Recent developments in Nd—Fe—B power”, 120th Topical Symposium of the Magnetics Society of Japan, pp. 23-23 (2001)
<Non-Patent Document 4> S. Hirasawa, H. Kanekiyo, T. Miyoshi, K. Murakami, Y. Shigemoto, T. Nishiuchi, “Structure and magnetic properties of Nd₂Fe₁₄B/Fe_{X}B-type nanocomposite permanent magnets prepared by strip casting”, 9th Joint MMM/INTERMAG, CA (2004) FG-05
<Non-Patent Document 5> H. A. Davies, J. I. Betancourt, C. L. Harland, “Nanophase Pr and Nd/Pr based rare-earth-iron-boron alloys”, Proc. of 16th Int. Workshop on Rare-Earth Magnets and Their Applications, Sendai, pp. 485-495 (2000)

<Non-Patent Document 6> G. Tokunaga, “Magnetic Characteristic of Rare-Earth Bond Magnets, Magnetic Powder and Powder Metallurgy”, Vol. 35, pp. 3-7 (1988)

<Non-Patent Document 7> H. Sakamoto, M. Fujikura and T. Mukai, “Fully-dense Nd—Fe—B magnets prepared from hot-rolled anisotropic powders”, Proc. 11th Int. Workshop on Rare-Earth Magnets and Their Applications, Pittsburg, pp. 72-84 (1990)
<Non-Patent Document 8> M. Doser, V. Panchanacthan, and R. K. Mishra, “Pulverizing anisotropic rapidly solidified Nd—Fe—B materials for bonded magnets”, J. Appl. Phys., Vol. 70, pp. 8603-6805 (1991)
<Non-Patent Document 9> T. Iriyama, “Anisotropic bonded NdFeB magnets made from hot-upset powders”, Polymer Bonded Magnet 2002, Chicago (2002)
<Non-Patent Document 10> T. Takeshita, and R. Nakayama, “Magnetic properties and micro-structure of the Nd—Fe—B magnetic powders produced by hydrogen treatment”, Proc. 10th Int. Workshop on Rare-earth Magnets and Their Applications, Kyoto, pp. 551-562 (1989)
<Non-Patent Document 11> K. Morimoto, R. Nakayama, K. Mori, K. Igarashi, Y. Ishii, M. Itakura, N. Kuwano, K. Oki, “Nd₂Fe₁₄B-based magnetic powder with high remanence produced by modified HDDR process”, IEEE. Tran. Magn., Vol. 35, pp. 3253-3255 (1999)
<Non-Patent Document 12> C. Mishima, N. Hamada, H. Mitarai, and Y. Honkura, “Development of a Co-free NdFeB anisotropic magnet produced d-HDDR processes powder”, IEEE. Trans. Mang., Vol. 37, pp. 2467-2470 (2001)
<Non-Patent Document 13> N. Hamada, C. Mishima, H. Mitarai and Y. Honkura, “Development of anisotropic bonded magnet with 27 MGOe” IEEE. Trans. Magn., Vol. 39, pp. 2953-2956 (2003)
<Non-Patent Document 14> D. Johnson, P. Pillay and M. Malengre, “High speed PM motor with hybrid magnetic bearing for kinetic energy storage”, IEEE Industry Applications Society Annual Meeting, Chicago 2001

For example, Japanese Patent No. 2911017 discloses the following magnet manufacturing method. A green compact of an arc-shaped segment having an outer diameter of 15.2 mm, an inner diameter of 10.8 mm, a length of 18.0 mm and a volume of 6.47 cm³ is formed such that fine powder of alloy composition Nd_{14.0}Dy_{1.0}Fe_{77.0}Al_{1.0}B_{7.0} having an average particle size of 3.5 μm is compressed at about 100 MPa, and four of such green compacts are combined and formed under a hydrostatic pressure of 200 MPa into a ring-shaped green compact having an outer diameter of 27A mm, an inner diameter of 19.4 mm, a height of 16.2 mm and a volume of 4.76 cm³. Subsequently, the green compact is sintered for two hours at 1090° C. in a vacuum atmosphere and then subjected to an aging treatment for one hour at 580° C., thus completing a ring-shaped sintered magnet. It is described therein that a 2 mm cube cut out from an arbitrary portion of the ring-shaped sintered magnet fabricated as described above has uniform magnetic properties. That is to say, in the manufacturing method described above, a plurality of arc-segment compacts, each of which has a thickness of 4.4 mm and is brittle, are combined and hydrostatically formed into a ring-shaped compact having a thickness of 4.0 mm, and the ring-shaped compact is subjected to pressureless sintering and thereby rigidified in an integral manner.

On the other hand, D. Johnson et al. disclosed a “quasi-Halbach array” in which rectangular anisotropic sintered magnets are embedded at respective predetermined positions of a ring-shaped soft magnetic body as shown in FIG. 1B, rather than a “Halbach array” in which segments are hydrostatically formed into a ring-shaped compact and the compact is sintered under ordinary pressure as shown in FIG. 1A. In FIGS. 1A and 1B, M refers to an anisotropy direction (magnetization direction) of the magnet, 1m refers to a segment of an inner rotor, 1′m refers to a rectangular magnet embedded in a yoke 1′y, and 2 refers to an open space for accommodating a stator. Such a quasi-Halbach array is proposed for the following reasons: the degree of anisotropy is decreased because the segments are formed into a ring shape having a thickness reduced by about 10% in no magnetic field as described in Japanese Patent No. 2911017; the volume contraction during pressureless sintering and the thermal expansion difference based on the anisotropy can be a factor to increase the internal distortion of the ring-shaped magnet, which results in that cracks and distortions easily occur and also that grinding work is inevitable thus rendering a low yield rate; there is a limit in workability with regard to increasing the number of pole-pairs as well as to reducing the diameter and the thickness; and while a high-speed rotation is definitely necessary to make up for the output decrease following the torque decrease resulting from the miniaturization of electromagnetic drive units, a small mechanical defect at the joint interface and an internal distortion have a crucial influence on the reliability of a high-speed motor.

In the quasi-Halbach array of D. Johnson et al. shown in FIG. 1B′ in which rectangular anisotropic sintered magnets are embedded at respective predetermined positions of a ring-shaped soft magnetic body, a uniform static magnetic field as seen in the Halbach-array of FIG. 1A′ cannot be achieved in the open space 2 for accommodating a stator. Moreover, the magnetic field line distribution achieved by pressureless sintering as described in Japanese Patent No. 2911017 is a static magnetic field distribution as shown in FIG. 1A′, which prohibits a full control of the anisotropy direction, thus resulting in failure to optimize the static magnetic field distribution according to individual motor structures.

### SUMMARY OF THE INVENTION

The present invention has been made in view of the circumstances described above, and it is an object of the present invention to provide a rare-earth iron-based magnet in which the direction of anisotropy can be duly controlled.

In order to achieve the object described above, according to an aspect of the present invention, there is provided a rare-earth iron-based magnet with self-recoverability, which includes a plurality of segments, wherein the segments each include a matrix having a microstructure in which rare-earth iron-based aligned magnetic powders of at least one kind are solidified by a cross-linking reaction phase and also in which the cross-liking reaction phase and a viscous deformation phase resulting from a viscosity flow are chemically bound to each other between the magnetic powders, and wherein while the inner and outer circumferential surfaces of the segments are constrained, fracture surfaces of the segments, and also the segments on a needed-basis, are mutually aggregated and rigidified together by taking advantage of self-recovery function based on viscous deformation caused by heat and external force and also on cross-linking reaction.

In the aspect of the present invention, the rare-earth iron-based magnetic powders of at least one kind may have a (BH)ₘₐₓ of 250 kJ/m³ or more and a volume fraction of 80 vol. % or more, and further the rare-earth iron-based magnetic powders, the cross-linking phase and the viscous deformation phase may account in total for 97 vol. % or more, and voids may account for 3 vol. % or less in terms of volume fraction.

In the aspect of the present invention, the difference in maximum magnetization Mₘₐₓ between the segment and a magnet corresponding to the segment may be 0.03 T or less, and the difference in anisotropy dispersion 8 therebetween may be 7% or less.

In the aspect of the present invention, the rare-earth iron-based magnet may have a remanence Mr of 0.95 T or more, a coercivity (HcJ) of 0.95 MA/m or more and a (BH)ₘₐₓ of 160 kJ/m³.

In the aspect of the present invention, the rare-earth iron-based magnet may have an annular shape such as arc, circular cylinder and the like, include at least one pole pair, have a permeance coefficient Pc of 3 or more and may constitute a magnetic circuit together with an iron core.

According to the present invention, a rare-earth iron-based magnet with self-recoverability includes a plurality of segments, wherein the segments each include a matrix having a microstructure in which rare-earth iron-based aligned magnetic powders of at least one kind are solidified by a cross-linking reaction phase and also in which the crass-liking reaction phase and a viscous deformation phase resulting from on a slip flow are chemically bound to each other between the magnetic powders, and wherein while the inner and outer circumferential surfaces of the segments are constrained, fracture surfaces of the segments, and also the segments on a needed-basis, are mutually aggregated and rigidified together by means of self-recovery function based on viscous deformation caused by heat and external force and also on cross-linking reaction. Accordingly, the magnet described above for use as a magnet with a thickness of 1 to 2 mm for an electromagnetic drive unit like a small motor is flexible in reduction of diameter and thickness, making thickness uneven, increase in length and like requirements to achieve the design concept of the electromagnetic drive unit. In addition, the self-recovered boundary surfaces of fragmented segment or a plurality of segments are uniform and mechanical defects are not built up heavily in the boundary region. Further, it is configured that only the direction of anisotropy can be controlled without deteriorating the degree of anisotropy of the magnet corresponding to the self-recoverable segment.

Thus, in order to comply with the design concept of an electromagnetic drive unit like a small motor, the self-recoverable rare-earth iron-based magnet can be configured into a Halbach array where a plurality of self-recoverable segments are combined, or into a magnet which has a high (BH)ₘₐₓ and in which the anisotropy direction is continuously controlled. Consequently, a strong static magnetic field distribution optimal for individual electromagnetic drive units having respective different structures and operations can be achieved.

In this connection, an ring-shaped self-recoverable iron-based magnet, which is formed such the rare-earth iron-based magnetic powder according to the present invention is highly densely filled and which has a permeance coefficient of 3 or more in a magnetic circuit constituted together with an iron core proves to be advantageous for providing a small-sized, highly reliable, high-output and highly efficient electromagnetic drive unit.

Accordingly, a high-output and highly efficient small electromagnetic drive unit can be provided by using the self-recoverable rare-earth iron-based magnet according to the present invention including a Halbach array with at least one pole pair.

### BRIEF DESCRIPTION OF THE DRAWINGS

FIGS. 1A and 1A′ are schematic views of a Halbach array, respectively showing a cross section and a static magnetic field distribution, and FIGS. 1B and 1B′ are schematic views of a quasi-Halbach array, respectively showing a cross section and a static magnetic field distribution;

FIGS. 2A to 2C are schematic views of a microstructure between magnetic powders and an action and effect thereof;

FIGS. 3A to 3C are schematic views of an action and effect of an anisotropy direction control;

FIGS. 4A and 4B are characteristic graphs of an action and effect of a self-recoverability;

FIGS. 5A and 5B are characteristic graphs, respectively showing an oscillation torque & alignment degree as a function of temperature, and M-H loops;

FIGS. 6A and 6B are cross sectional views, respectively showing a self-recoverable segment and a ring-shaped magnet, and FIG. 6C is a characteristic graph of relation between weight, length and density;

FIG. 7 is a scanning electron micrograph (SEM) of a self-recovery state;

FIGS. 8A and 8B are characteristic graphs, respectively showing a magnetization vector distribution and a surface magnetic flux distribution with respect to a radial direction;

FIG. 9 is a cross sectional view of a direction and a distribution of an anisotropy; and

FIG. 10A is a cross sectional view of collection locations of samples, and

FIG. 10B is a characteristic graph of relation between orientation and maximum magnetization Mₘₐₓ of the samples.

### DETAILED DESCRIPTION OF THE INVENTION

Description will first be made on one or more kinds of anisotropic rare-earth iron boride/nitride magnetic powders according to the present invention.

The anisotropic rare-earth magnetic powder (hereinafter, referred to simply as “magnetic powder” as appropriate) of the present invention is fabricated such that Sm—Fe-based alloy or Sm—(Fe, Co)-based alloy is produced, for example, by a dissolution casting method described in Japanese Patent Application Laid-Open No H2-57663 or by a reduction diffusion method disclosed in Japanese Patent No. 17025441 and Japanese Patent Application Laid-Open No. H9-157803, and such alloy is nitrided and then finely milled. The fine milling process can be performed by a publicly known technique such as a jet mill, a vibration ball mill, a rotation ball mill or the like. The magnetic powder of the present invention is to refer to Sm₂Fe₁₇N₃-based magnetic powder which is finely milled so as to have a fisher average particle size of 1.5 μm or less, preferably 1.2 μm or less. In this connection, it is preferable if the surface is coated with a slow oxidation film as disclosed, for example, in Japanese Patent Applications Laid-Open Nos. S52-54998, S59-170201, 560-128202, H3-211203, S46-7153, S56-55503, S61-154112, and H3-126801. Also, the magnetic powder of the present invention may be one or more kinds of Sm₂Fe₁₇N₃ powders subjected to surface treatment conducted by a method which is to form a metallic coating film and which is disclosed in Japanese Patent Applications Laid-Open Nos. H5-230501, H5-234729, H8-143913, and H7-268632, or the Japan Institute of Metals, Lecture Outline (Spring General Assembly of 1996, No. 446 P 184), or by another method which is to form an inorganic coating film and which is described in Japanese Examined Patent Application Publication No. 116-17015 and Japanese Patent Applications Laid-Open Nos. H1-234502, H4-217024, H5-213601, H7-326508, H8-153613, H8-183601.

Further, the magnetic powder of the present invention may be what is called “HDDR-R₂Fe₁₄B-based magnetic powder”, “Co-free d-HDDR-R₂Fe₁₄B-based magnetic powder”, or their surface-treated powder, which are fabricated such that R₂(Fe, Co)₁₄B based alloy (R is Nd, Pr) is hydrogenated (hydrogenation, R₂(Fe, Co)₁₄B H_{X}), is phase-decomposed at 650 to 1000° C. (decomposition, RH₂+Fe+Fe₂B), is hydrogen-desorbed (desorption) and is recombined (recombination), as disclosed, for example, in Japanese Patents Nos. 3092672, 2881409, 3250551, 3410171, 3463911, 3522207, and 3595064.

In addition to the anisotropic rare-earth iron boride/nitride magnetic powders described above, Sm—Co-based, Mn—Al—C-based or Al—No—Co-based non-rare-earth iron-based magnetic powder, or isotropic rare-earth magnetic powder having a remanence (Mr) of as high as 1 T or more may be appropriately used in parallel as needed.

The one or more kinds of anisotropic rare-earth iron boride/nitride magnetic powders according to the present invention preferably have a (BH)ₘₐₓ of 250 kJ/m³ or more, because a self-recoverable rare-earth iron-based magnet can easily achieve a (BH)ₘₐₓ of 160 kJ/m³ or more if the volume fraction of aligned rare-earth iron-based magnetic powder with a (BH)ₘₐₓ of 250 kJ/m³ or more according to the present invention is set to 80 vol. % or more.

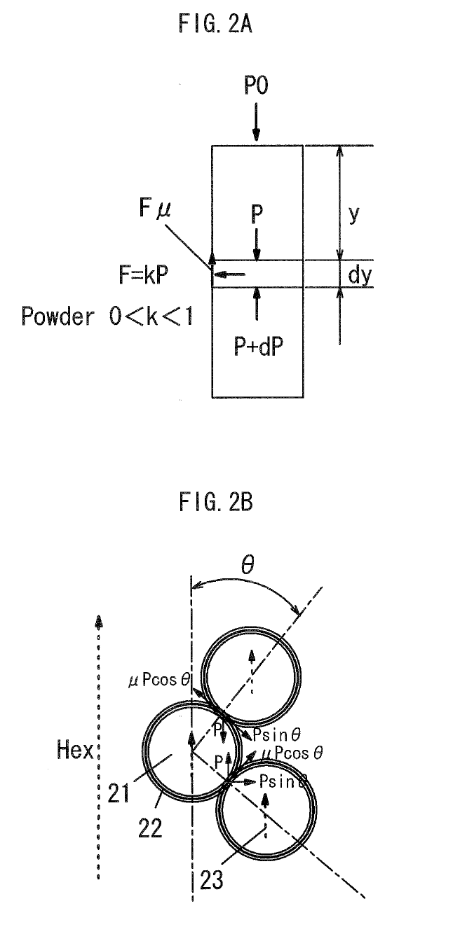

Description will now be made, with reference to FIGS. 2A, 2B and 2C, on a microstructure formed such that the pre-aligned anisotropic rare-earth iron-based magnetic powder according to the present invention is solidified by a cross-linking reaction phase wherein a cross-linking reaction phase and a viscous deformation phase are chemically bound together between the magnetic powders, and also the action and effect of the microstructure will be described.

Referring to FIG. 2A, when magnetic powder is compacted and if attention is focused on a circular plate portion having a thickness dy, since the total pressure on the upper surface of the circular plate portion is πr²P while the total pressure on the lower surface is obtained by the sum of πr²(P+dP) plus friction force (kP×2πr dy)μ, the equilibrium equation is expressed by: πr²P=πr²(P+dP)+(kP×2πr dy)μ. This equation is solved as follows: P=Po exp(−2 kμy/r). Therefore, the compacting pressure Po decays exponentially in the magnetic powder. So, it is necessary to suppress the decay of pressure with respect to the pressure axis direction to thereby enhance the pressure transmission.

In order to enhance the pressure transmission, it is necessary to reduce individual coefficients μ of frictions arising from the compaction of the magnetic powder. Accordingly, in the present invention, internal lubricant is added and also the matrix at the time of compacting the magnetic powder is defined by liquid phase, wherein the internal lubricant previously added is eluted so as to produce an internal sliding effect, whereby when the magnetic power is compacted, the entire system is brought in sliding flow condition. As a result, according to the present invention, relative density, including the matrix, can be 97 vol. % or more under a low pressure of 20 to 50 MPa.

A macromolecule-chain is named as a preferred viscous deformation phase to constitute the matrix according to the present invention, and, for example, a polyamide-12 having a number average molecular weight (Mw) of 4000 to 12000, or its copolymer, is given as an example. Further, the internal lubricant, which is used as an additive agent as needed, is preferably constituted by an organic compound which has a melting point of 50° C. and which contains, in one molecule, at least one each of the followings: hydrophilic functional group to accelerate elution from melted chain molecule away outside the system when the magnetic powder is compacted; and long-chain alkyl group to enhance the internal sliding effect when the magnetic powder is compacted. As a concrete example, an organic compound may be named which contains, in one molecule, one hydroxyl group (—OH) and also three hexadecyl groups of a carbon number 17 (—(CH₂)₁₇—CH₃).

In the meantime, further, in the present invention, when Sm₂Fe₁₇N₃-based magnetic powder having an average particle size of about 3 μm is used as rare-earth iron-based magnetic powder in order to improve the pressure transmission in the process of compacting the magnetic powder, for example, Nd₂Fe₁₄B-based magnetic powder having an average particle size of 100 to 150 μm is used together, which allows a constant k shown in FIG. 2A to be reduced (where the constant k is 1 and 0, respectively, when the compacted substance is liquid and solid).

When magnetic powder aligned by an external magnetic field Hex as shown in FIG. 2B is compacted, the equilibrium equation goes as follows: [(4/3)πr³×Ms×Hex×sin θ]−r(P μ cos θ−P sin θ+P μ cos θ+P sin θ)=0, and if the angle θ to satisfy the equation is defined as “φ”, the solution is obtained as follows: φ=tan⁻¹[3 Pμ(2r² Ms×Hex)]˜3Pμ/(2r² Ms×Hex). That is to say, the maintenance performance of the C-axis alignment at the time of compacting the magnetic powder increases in proportion to the second power of the particle size of the magnetic powder. Therefore, it is effective for maintaining the alignment degree at the time of compacting the magnetic powder if Nd₂Fe₁₄B-based magnetic powder having an average particle size of 100 to 150 μm is used in combination when, for example, Sm₂Fe₁₇N₃ having an average particle size of about 3 μm is used as rare-earth iron-based magnetic powder. In this connection, in FIG. 2B, 21 refers to a rare-earth iron-based magnetic powder, 22 refers to a cross-linking reaction phase which solidifies the rare-earth iron-based magnetic powder 21 in a three-dimensional network fashion and which, in the present invention, is constituted by, for example, a film formed such that an epoxy oligomer of about 40 to 60 nm is cross-linked three-dimensionally by cross-linking agent, and 23 refers to a C-axis (axis of easy magnetization) of the rare-earth iron-based magnetic powder 21 wherein “alignment of the magnetic powder 21” in the present invention is defined as a state in which the C-axes 23 of all the rare-earth iron-based magnetic powders 21 are aligned substantially with the direction of the external magnetic field Hex.

When chain molecules are melted, their particle chains can be represented as tangling thread-like lines (melted chain particles) 24 as shown in FIG. 2C. The melted chain particles 24 undergo slip flow, such as shear flow or elongation flow, according to the external force direction. In the present invention, however, since the melted chain particles 24 are chemically bound to the cross-linking reaction phases 22 and the resultant three-dimensional network structure constitutes an imperfect microstructure, it is prevented that the melted particles 24 present between the magnetic powders are eluted from between the magnetic powders by the slip flow arising due to the heat and the external force, and thus the melted particles 24 are allowed to stay between the magnetic powders so as to form viscous deformation phases to provide viscous deformation function between the magnetic powders.

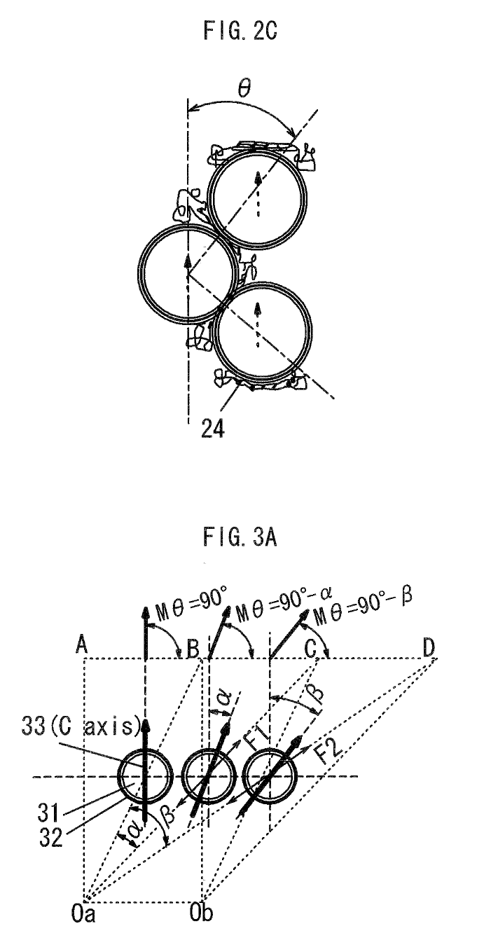

Description will now be made, with reference to FIG. 3A, on the action and effect of an anisotropy direction control which is based on fracture surface formation caused by heat and external force and also on viscous deformation while the inner and outer circumferential surfaces of the self-recoverable segment having a microstructure according to the present invention as shown in FIG. 2C are constrained.

FIG. 3A shows a minute rare-earth iron-based magnetic powder 31 located at the center of a diagonal line Oa-B of a self-recoverable segment cross section Oa-Ob-B-A, wherein 32 refers to a cross-linking reaction phase which solidifies the rare-earth iron-based magnetic powder 31 in a three-dimensional network structure and which is chemically bound to the chain particle, 33 refer to a C-axis (axis of easy magnetization), and M_{θ} refers to an angle to define the direction of the C-axis 33 of the rare-earth iron-based magnetic powder 31, that is to say, an angle to indicate the direction of the C-axis 33 with respect to a self-recoverable segment surface B-A, which, in other words, is the direction of anisotropy.

When the self-recoverable segment cross section Oa-Ob-B-A according to the present invention is deformed by an external force into a cross section Oa-Ob-C-B and further into a cross section Oa-Ob-D-C, the rare-earth iron-based magnetic powder 31 as a minute rigid body located at the center of the diagonal line Oa-B is relocated respectively at the center of a diagonal line Oa-C and further at the center of a diagonal line Oa-D while generating respective tensile forces F1 and F2 and causing respective rotations with angles α and β. Then, the angle M_{θ} to indicate the anisotropy direction is rotated by the angles α and β, respectively, with respect to the tangent line of a self-recoverable segment surface B-C-D. Thus, when the cross-linking reaction phase 22 is of an imperfect network structure containing chain particles, non-recoverable deformation is retained when the external force is released. The non-recoverable deformation occurs solely when plastic substances such as clay are deformed, where generally a slide occurs between the chain particles. Shearing is caused by the elongation and rotation of a minute portion, and in the present invention, the C-axis, that is to say, the anisotropy direction is controlled by the rotation of a rigid body of a specific minute portion solidified.

FIG. 3B schematically shows a state where the inner and outer circumferential surfaces of the self-recoverable segment having a microstructure as shown in FIG. 2C are constrained and at the same time the tensile forces F and F′ are applied, wherein since a shear force as shown in FIG. 3A is not involved in the magnetic powder 31, the rigid body of the minute portion in the magnetic powder 31 is not caused to rotate thus keeping the angle M_{θ} unchanged. Accordingly, it is indicated that a viscous deformation occurs while the direction of the C-axis 33, that is the anisotropy direction of the self-recoverable segment is held at an angle of 90 degrees with respect to wall surfaces 35a and 35b. Referring to FIGS. 3C and 3D, C_{θ} refers to an angle to represent a change in orientation of the wall surfaces 35a and 35b which is caused when a shear force by torsion is applied while the wall surfaces 35a and 35b are constrained, wherein when the angle M_{θ} is 90 degrees at the initial state as shown in FIG. 3B, the angle C_{θ} is 0 degrees, and when the M_{θ} is 0 degrees as shown in FIG. 3D, the angle C_{θ} is 90 degrees.

When the tensile forces F and F′ as well as heat are applied to the self-recoverable segment while the inner and outer circumference surfaces of the segment are constrained as shown in FIG. 3B, a crack is produced originating from a mechanical defect such as a void found in the self-recoverable segment and then grows, and a slip surface 34 (S1) is formed due to the elution of melted particles chemically bound to the cross-linking phase 32 as well as of internal lubricant. In addition, slip surfaces 34 (S2′) and 34 (S2) in accordance with shear stress are formed at respective boundary surfaces between the self-recoverable segment and the wall surfaces 35a and 35b. On the other hand, since the magnetic powders 31 are solidified by the cross-linking phase 32 in an incomplete three-dimensional network molecular structure, even when the distance from the wall surface 35a or 35b is decreased (compacted), the entire system undergoes a viscous deformation while the direction of the C-axis 33 is fixed in an incomplete three-dimensional network molecular structure. As a result, the angle M_{θ} defined between the direction of the C-axis 33 and the wall surfaces 35a and 35b is not changed in the entire system thus maintaining 90 degrees.

Now, when the angle C_{θ} to the wall surfaces 35a and 35b is 30 degrees as shown in FIG. 3C, that is to say, when the external force acts as a shear force rather than as a tensile force, slip surfaces are formed such that a slip surface 34 (S3) appears between the magnetic powders (31) while there are other slip surfaces appearing in the same way as the slip surfaces 34 (S1), 34 (S2) and 34 (S2′) shown in FIG. 3B. In this case also, the magnetic powders are solidified by the cross-linking phase 32 in an incomplete three-dimensional network molecular structure, and therefore a viscous deformation occurs in the entire system causing the rotation of the minute portion, specifically that is the rigid body like the magnetic powder 31. As a result, in the case if the angle C_{θ} with regard to the wall surfaces 35a and 35b is 30 degrees, then the angle M_{θ} defined between the direction of the C-axis 33 and the wall surfaces 35a and 35b changes in the entire system and measures 60 degrees.

Further, when the angle C_{θ} with regard to the wall surfaces 35a and 35b is 90 degrees as shown in FIG. 3D, major slip surfaces are formed in the same way as the slip surfaces 34 (S1), 34 (S2) and 34 (S2′) shown in FIG. 3B. In this case also, since the magnetic powders 31 are solidified by the cross-linking phase 32 in a three-dimensional network fashion, a viscous deformation occurs in the entire system causing the rotation of the minute portion, specifically, that is the rigid body like the magnetic powder 31. As a result, in the case if the angle C_{θ} to the wall surfaces 35a and 35b is 90 degrees, then the angle M_{θ} defined between the direction of the C-axis 33 and the wall surfaces 35a and 35b is changed in the entire system and measures 90 degrees.

As described above, also a ring-shaped configuration, in which the anisotropy direction alone is arbitrarily controlled continuously from the plane perpendicular direction to the in-plane, can be achieved from the Halbach array without lowering the degree of anisotropy of the aligned magnetic powders 31 by the action of the slip surface formation and the viscous deformation caused due to the heat and the external force while constraining the inner and outer circumferential surfaces of the self-recoverable segment according to the present invention having a microstructure in which a three-dimensional network and chain particles are cross-linked to each other.

The difference of maximum magnetization Mₘₐₓ between the self-recoverable segment according to the present invention and the magnet located corresponding to the segment is preferably 0.03 or less, and the difference of anisotropy dispersion 8 therebetween is preferably 7% or less. Also, it can be configured that only the anisotropy dispersion is different between the self-recoverable segment and the magnet located corresponding to the segment, or configured that no difference is present therebetween.

Also, the self-recoverable segment according to the present invention is preferably composed such that the volume fraction of a rare-earth iron-based magnetic powder is set at 80 vol. % or more, the remanence (Mr) is set at 0.95 T or more with respect to the anisotropy direction, the coercivity (HcJ) is set at 0.95 MA/m or more, and the (BH) value is set at 160 kJ/m³ or more.

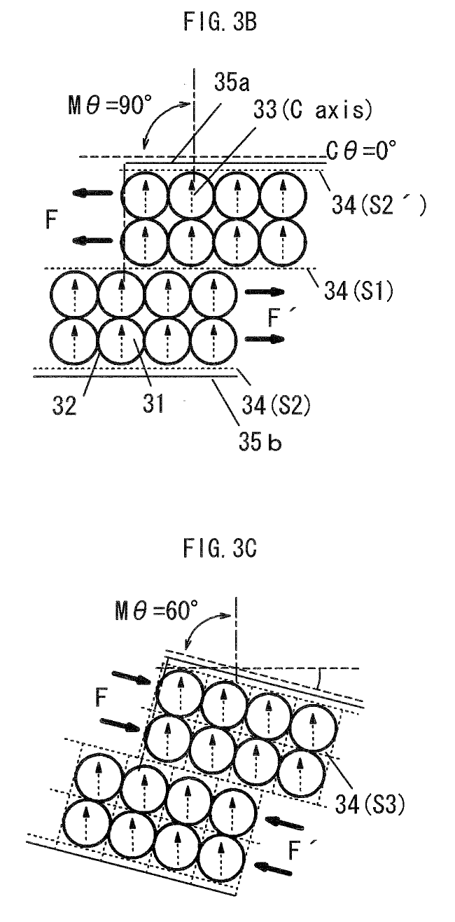

Description will be made, with reference to FIGS. 4A and 4B showing characteristic graphs based on the viscoelastic behavior of magnet, on the action and effect resulting from that a plurality of self-recoverable segments according to the present invention having the microstructure shown in FIG. 2C are aggregated into a desired shape, for example, a ring shape in such a manner that the anisotropy is directionally controlled by the action of fracture surface formation and viscous deformation caused due to the heat and the external force while the inner and outer circumferential surfaces of the self-recoverable segments are constrained as shown in FIGS. 3A to 3D, and subsequently that self-recovery is performed based on the external force and the cross-linking reaction.

A preferred system including the microstructure shown in FIG. 2C is composed of Nd₂Fe₁₄B and Sm₂Fe₁₇N₃ which have respective particle sizes of 38 to 150 μm and 3 to 5 μm and which account, in aggregate, for a volume fraction of 80.8 vol. %, while the rest which accounts for a volume fraction of 10.2 vol. % consists of a cross-linking phase to solidify the magnetic powder, a viscous deformation phase and an additive agent used as needed.

The cross-linking phase is mainly composed of, for example, o-cresol novolak epoxy oligomer having an epoxy equivalent of 205 to 220 g/eq and a melting point of 70 to 76° C. An imidazole adduct (2-phenyl-4,5-dihydroxymethylimidazole) having a decomposition temperature of 230° C. is used as a cross-linking agent. A linear polyamide which contains amino active hydrogen in molecular chain adapted to bind chemically to an oxazolidone ring of the aforementioned epoxy oligomer and which has an average molecular weight Mw of 4000 to 12000 is used as a chain molecule of the viscous deformation phase. And, a partial ester compound which is formed between pentaerythritol and higher fatty acid and which has a melting point of about 52° C. can, for instance, be used as an internal lubricant acting effectively as the additive agent on a needed basis, because the partial ester compound includes, in one molecule, one hydroxyl group (—OH) and three hexadecyl groups of a carbon number 17 (—(CH₂)₁₇—CH₃) wherein the polar group has compatibility with melted chain molecule and the hexadecyl group has a lubricating action resulting from slip flow phenomenon.

In the present invention, a compound can be preferably exemplified which is prepared in the following manner: a composition, which is composed of rare-earth iron-based magnetic powder coated with epoxy oligomer having a thickness of 40 to 50 nm as a main component of the cross-linking phase, linear oligomer as the sliding phase, and additive agent used as needed, and which does not contain a cross-linking agent, is melted and kneaded together by using, for example, a mixing roll heated to 140 to 150° C. into a kneaded mixture; the kneaded mixture is cooled at room temperature, milled to a size of, for example, 710 μm or smaller and classified; and the milled substance is dry-mixed with a cross-linking agent and formed into a granule.

FIG. 4A is a characteristic graph showing a time-dependent variation in normalized oscillation torque of the compound described above, wherein 20 g of the compound is filled in a cylindrical die which has a diameter of about 30 mm and which is preheated to 160° C., a sinusoidal torsion vibration with a torsion angle of ±0.5 degrees as well as with a cycle of 6 seconds is applied to the compound while the compound is compacted at a pressure of 96 kPa, whereby a sinusoidal torsion vibration torque resulting from the cross-linking reaction of the system is detected by means of forty eight grooves (0.5 mm deep, 0.5 mm wide) extending radially from an inner radius of 3 mm from the center of a torsion plane.

As shown in FIG. 4A, the oscillation torque decreases at first and then, after gelation, starts to rapidly increase in accordance with the development of the cross-linking reaction. Subsequently, the increase rate declines gradually and reaches a saturation region indicating that the cross-linking is finished.

FIG. 4B is a characteristic graph showing a time-dependent variation in normalized oscillation torque at the vicinity of a reaction rate of 80% (1200 sec), where oscillation torque is normalized such that its saturation value is set to 1 and its minimum value is set to 0. As described above with reference to FIG. 4A, in the entire system according to the present invention, the oscillation torque increases with the development of the cross-linking reaction and reaches the saturation region. More specifically, in the time-dependent variation according to the present invention, the oscillation torque, while repeating increase and decrease periodically after gelation of the system, increases macroscopically and reaches the saturation region. This fact reflects the phenomenon that the oscillation torque decreases due to the fracture surface formation caused by the heat and the external force at the grooves provided on the torsion plane, and also that the oscillation torque recovers due to the sliding phase and the cross-linking reaction phase according to the present invention. That is to say, this indicates that even if a mechanically fractured surface is formed by the heat and the external force in a part or the entire part of the gelated system according to the present invention, the surface fractured is recovered by the viscous deformation and the cross-linking reaction, meaning that self-recoverability is obtained. Thus, the rare-earth iron-based magnet with self-recoverability according to the present invention is featured with such novel rheology-related characteristics.

After the anisotropy direction control is performed as needed in an arbitrary manner as described above, fracture surfaces or also segments can be mutually aggregated by the viscous deformation and the cross-linking reaction.

Further, according to the present invention, the self-recoverable segment fragments and also the segments are mutually aggregated and then rigidified together by increasing cross-linking density with heat treatment, whereby environment resistance, such as mechanical strength and dimensional stability required for a magnet, can be ensured.

In addition, in the self-recoverable rare-earth iron-based magnet according to the present invention, it is preferably arranged that the sum of the volume fraction (that is the relative density) of the rare-earth iron-based magnetic powder, the cross-linking reaction and the viscous deformation phase accounts for 97 vol. % or more and the void ratio accounts for 3 vol. % or less. The reason for the arrangement described above is because when the components described above, after re-aggregation due to the self-recovery, are rigidified together by heat, the magnetic properties are advantageously suppressed from deteriorating due to oxidation reaction by heat treatment in the air.

An electromagnetic drive unit using the recoverable rare-earth iron-based magnet as described above according to the present invention is preferred so that a magnetic circuit structure, in which the magnet has a pole pair number of 1 or more and a permeance coefficient Pc of 3 or more, ensures demagnetization resistance against the reversed magnetic field generated from the iron core side (exciting winding) of the magnet.

Thus, an anisotropic magnet including a Halbach array with a pole pair number of 1 or more, as well as a high-output and high-efficiency small electromagnetic drive unit incorporating such a magnet can be provided.

### EXAMPLES

The present invention will be described in more details with reference to invention examples. It should be, however, noted that the present invention is by no means limited to the examples.

<Adjustment of self-recoverable segment> The sum of the volume fraction of Sm₂Fe₁₇N₃ (Mr=1.22 T, HcJ=0.91 MA/m, (BH)ₘₐₓ=240 kJ/m³) having a particle size of 3 to 5 μm and Nd₂Fe₁₄B (Mr=1.34 T, HcJ=1.15 MA/m, (BH)ₘₐₓ=316 kJ/m³) having a particle size of 38 to 150 μm is set to 80.8 vol. %, and the rest of 19.2 vol. % is composed of 6.5 vol. % o-cresol novolak epoxy oligomer having an epoxy equivalent of 205 to 220 g/eq and a melting point of 70 to 76° C., and functioning as a cross-linking reaction phase to solidify the magnetic powders; 1.8 vol. % imidazole derivative (2-phenyl-4,5-dihydroxymethylimidazole) having a decomposition temperature of 230° C.; 9.1 vol. % linear polyamide having an average molecular weight Mw of 4000 to 12000, containing amino active hydrogen atoms in molecular chain to bind chemically to an oxazolidone ring of the aforementioned epoxy oligomer, and functioning as a chain molecule of the viscous deformation phase; and 1.8 vol. % partial ester compound of pentaerythritol and higher fatty acid, functioning as an internal lubricant. In the above composition, one hydroxyl group (—OH) and three hexadecyl groups of a carbon number 17 (—(CH₂)₁₇—CH₃) are included in one molecule, so that the polar group works to improve compatibility with melted chain molecule, and the hexadecyl group works to improve self-recoverability resulting from slip flow.

First, the composition components according to the present invention excluding the cross-linking agent were melted and kneaded together by using a mixing roll whose front and back roll temperatures are set to 140° C. and 150° C., respectively. The melting and kneading process for eliminating the voids is conducted in order to ensure the low-pressure compressibility and to suppress the degradation of the squareness characteristic of demagnetization curve attributable to the surface oxidation of the rare-earth iron-based magnetic power.

Subsequently, the above kneaded mixture was milled to a size of 710 μm or smaller and classified at room temperature, the classified substance was dry-mixed with a cross-linking agent having an average particle size of 3 μm, and a granule compound was fabricated.

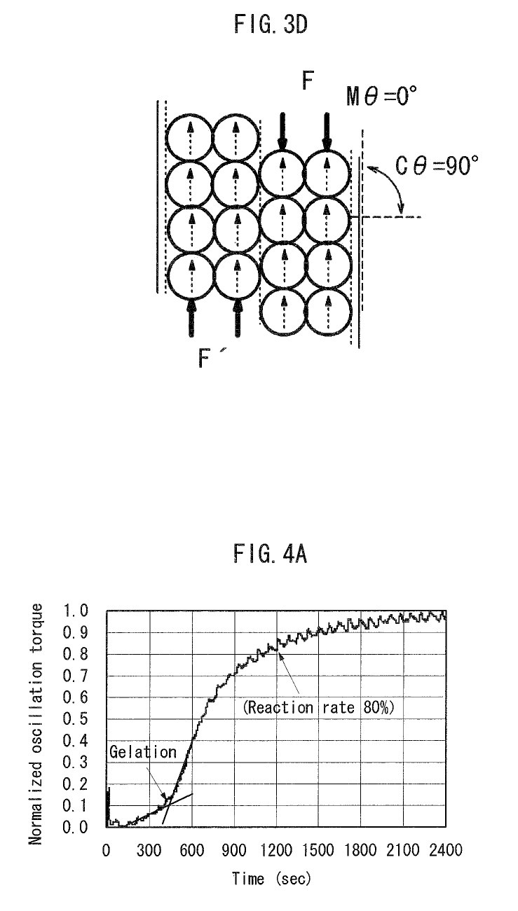

FIG. 5A is a characteristic graph which shows the temperature dependency of oscillation torque measured when the temperature is raised at a constant rate while a sinusoidal torsion vibration is applied to the above described compound according to the present invention, and which also shows the temperature dependency of alignment degree of the rare-earth iron-based magnetic powder obtained by dividing the remanence (Mr) by the maximum magnetization Mₘₐₓ, and FIG. 5B is a characteristic graph showing representative M—H loops according to the present invention.

The sample used for the measurement of magnetic characteristics is a 7 mm cube with a density of 6.0 to 6.2 Mg/m³ which was compacted in an orthogonal magnetic field of 1.4 MA/m under a pressure of 50 MPa temperature of 110 to 160 b° C. In this connection, Sm₂Fe₁₇N₃/Nd₂Fe₁₄B magnet obtained by compacting under a high pressure of 1.5 Gpa has a problem of magnetic characteristic deterioration resulting from generation of new surfaces or damage of surfaces due to the fracture of Nd₂Fe₁₄B (K. Noguchi, K. Machida, G. Adachi, “Preparation and characterization of composite-type bonded magnets of Sm₂Fe₁₇N_{X} and Nd—Fe—B HDDR powders”, Proc. 16th Int. Workshop on Rate Earth Magnets and Their Applications, pp. 845-854, 2000). However, according to the example of the present invention, the rare-earth iron-based magnetic powders are isolated from one another by the cross-linking phase and the viscous deformation phase, and the relative density of the composition exceeds 97 vol. % under a slight pressure of 50 MPa in the heat and in the magnetic field. Consequently, the magnetic characteristic deterioration due to the generation of new surfaces and the damage of surfaces in Nd₂Fe₁₄B can be suppressed.

Referring to FIG. 5A, in the temperature range of 120 to 160° C., the alignment degree (Mr/Mₘₐₓ) of the rare-earth iron-based magnetic powder increases while the oscillation torque is observed to decrease. However, in the temperature range exceeding a temperature point 5(a)1 at which the oscillation torque starts to increase, the alignment degree (Mr/Mₘₐₓ) decreases. In the present example, it is preferred to align the rare-earth iron-based magnetic powder at such a temperature as a temperature point 5(a)2 which is slightly lower than the temperature point 5(a)1 described above. Also, a ring-shaped magnet taking advantage of the self-recoverability according to the present example is preferably formed at a temperature range 5(a)3 where the viscous deformation and the crosslinking reaction work.

FIG. 5B shows typical room temperature M-H loops according to the present example obtained at the temperature point 5(a)2, wherein the magnetic properties were as follows: remanence Mr=0.99 T; coercivity HcJ=1.03 MA/m; and (BH)ₘₐₓ=167.5 kJ/m³. Thus, if the requirements for the self-recoverable rare-earth iron-based magnet are satisfied, the magnetic properties of: remanence Mr=0.95 T or more; coercivity HcJ=0.95 MA/m or more; and (BH)ₘₐₓ=160 kJ/m³ or more can be achieved easily. In this connection, Matsunaga et al. disclose that a magnet fabricated by compacting together rare-earth iron-based magnetic powder and epoxy rein, when cross-linked, is heat treated in Ar atmosphere at the lowest possible temperature in order to suppress the oxidation degradation of the magnetic properties (H. Matsunaga, M. Ohkita, S. Mino and N. Ishigaki, “Technique of compaction molding anisotropic bonded NdFeB magnet”, the Magnetics Society of Japan, vol. 20, pp. 217-220 (1996)). On the other hand, in the magnet according to the present example which satisfies the requirements of the present invention, the magnetic properties are not degraded even if the magnet is hardened by heat treatment conducted in the air at 170° C. for 20 minutes.

A magnet which is fabricated by compacting Sm₂Fe₁₇N₃ magnetic powder and at the same time which has a density of 5 Mg/m³ or more has not been available. For example, a magnet, which is fabricated by compacting Sm₂Fe₁₇N₃ magnetic powder together with liquid saturated polyester resin composition at room temperature, has a density of 4.79 Mg/m³, a relative density of 62.5% calculated based on the true density of 7.67 Mg/m³, and a (BH)ₘₐₓ of 94.7 kJ/m³ (K. Ohmori, S. Hayashi, S. Yoshizawa, “Injection molded Sm—Fe—N anisotropic magnets using unsaturated polyester resin”, Proc. Rare-Earth's 04 in Nara, (2004) J0-02).

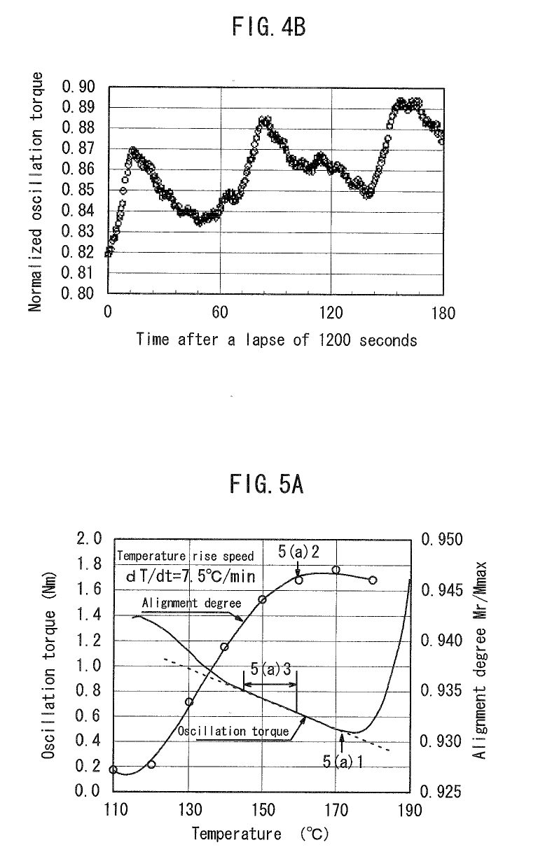

Based on the intersection points between the operating line having a permeance coefficient Pc of 3 and the demagnetization curves in the second quadrant of the room temperature M—H loops in FIG. 5B, the permeance coefficient Pc of the magnetic circuit structure of the magnet according to the present invention and the iron core is preferably set to approximately 3 or more, which is advantageous for ensuring demagnetization resistance of the inventive magnet against a reversed magnetic field produced from the iron core side (exciting winding) of the magnet. In this connection, in an electromagnetic drive unit like a rotary machine, a radial gap type electromagnetic drive unit generally is effective in providing a magnetic circuit structure in which the iron core and the inventive magnet have a permeance coefficient Pc of 3 or more.

<Aggregation of segments based on self-recoverability> A self-recoverable segment Seg. 61 with a cross section shown in FIG. 6A was prepared using the compound according to the present example based on the adjustment conditions to achieve the M—H loops shown in FIG. 5B, that is, at a temperature of 160° C., in a magnetic field of 1.4 MA/m and at a pressure of 50 MPa. Referring to FIG. 6A, the self-recoverable segment Seg. 61 is shaped to have an outer radius of 3.46 mm and an inner radius of 1.84 mm, wherein the magnetic powders are aligned in the direction indicated by the C-axis which is parallel to the direction of the uniform magnetic field Hex, thus forming a so-called “parallel orientation”.

Next, four (Seg. 61-1 to Seg. 61-4) of the above recoverable segment Seg. 61 were arranged, as shown in FIG. 6B, in a ring cavity having an outer diameter of 6.990 mm and an inner diameter of 3.605 mm, were compacted at a temperature of 140 to 160° C., in no magnetic field, under a maximum pressure of 500 MPa and with no retention time, released from the mold and then subjected to heat treatment in the air at 170° C. for 20 minutes. Thus, the ring-shaped magnet according to the present invention was obtained which is formed such that self-recoverable segments are rigidified together.

FIG. 6C is a characteristic graph showing relation between weight W (g), length L (mm) and density d (Mg/m³) of the ring-shaped magnet according to the present example. As shown in FIG. 6C, L is proportional to W with a correlation coefficient of R²=0.9999, and a long ring-shaped magnet having a length-to-outer diameter ratio (L/OD) of up to 3.2 can be obtained. Also, the density ranges from 6.25 to 6.35 Mg/M³ in spite of the compaction performed under a pressure of as low as 50 MPa. In this connection, the mixing system according to the present example which is composed of Sm₂Fe₁₇N₃ (true density: 7.67 Mg/m³) and Nd₂Fe₁₄B (true density: 7.55 Mg/m³) has a true density of 7.598 Mg/m³, Consequently, the magnet according to the present example has a relative density RD of 82.2 to 82.7%, which is about as much as, or more than the relative density (80 vol. %) of a magnet formed such that Nd₂Fe₁₄B obtained by rapid solidification such as melt spinning is compacted together with epoxy resin under a pressure of about 1 Gpa.

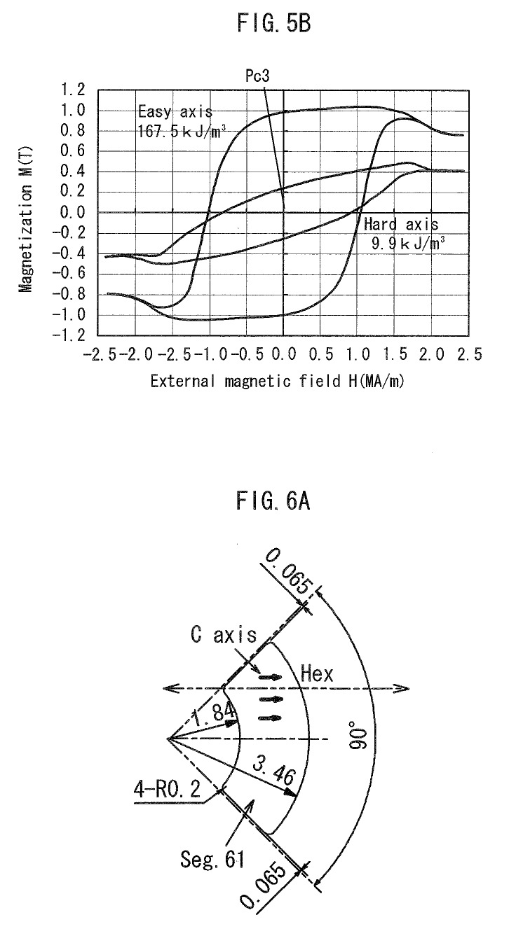

FIG. 7 is a scanning electron micrograph (SEM) of a fracture surface of a joint region between the self-recoverable segments Seg. 61-1 and Seg. 61-2 of the ring-shaped magnet according to the present example. When a plurality of segment compacts as shown in, for example, Japanese Patent No. 2911017 are combined, formed into a ring shape under thickness hydrostatic pressure and rigidified together by atmospheric sintering, the joint surface can be visually recognized thus raising mechanical defects. It is also disclosed therein that a joint material is used together for acceleration of atmospheric sintering and homogenization at the joint interface. On the other hand, in the magnet according to the present invention which is formed into a ring shape with self-recoverability and rigidified together by a subsequent heat treatment, a uniform fracture surface is seen also at the joint interface where no trace of mechanical defects are built up heavily.

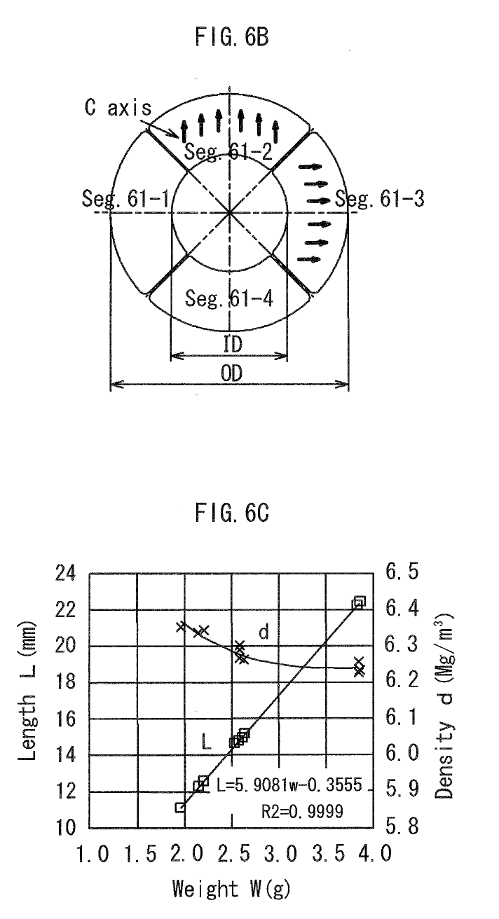

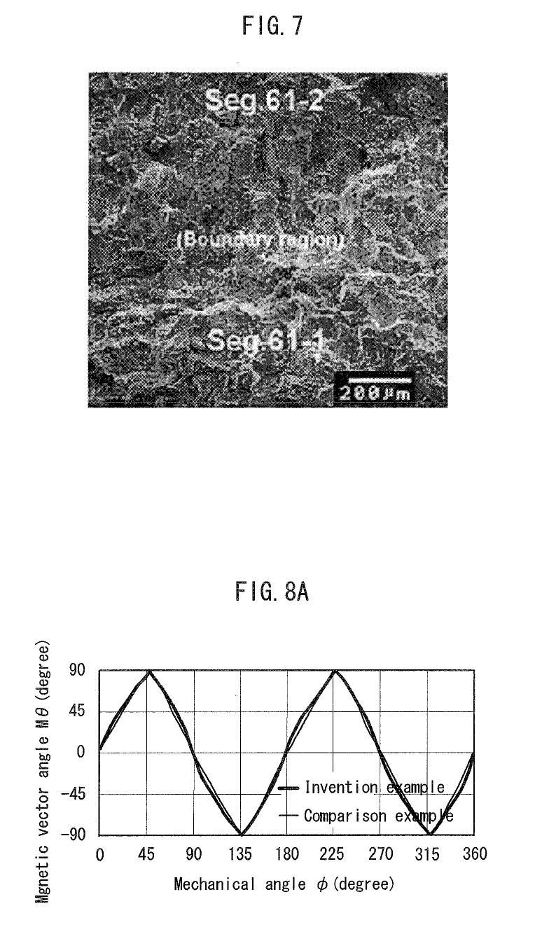

FIGS. 8A and 8B are characteristic graphs showing respective magnetization states of the ring-shaped magnet according to the present invention having a pole pair number of 2, which are results measured by a 3D Tesla meter, wherein FIG. 8A shows a distribution of a magnetization vector angle M_{θ} as a function of a mechanical angle φ and FIG. 8B shows a distribution of a surface magnetic flux density φs with respect to a radial direction as a function of the mechanical angle φ. The magnetization vector angle M_{θ} refers to, as shown in FIG. 9, a angle M_{θ1} or M_{θ2} formed with a circumferential tangent line (for example, A-A′, B-B′ in the figure) at an arbitrary point of the mechanical angle φ. The angle M_{θ1} or M_{θ2} indicates the anisotropy direction at an arbitrary point of the mechanical angle, and the distribution with respect to the mechanical angle φ indicates the anisotropy distribution.

The present example shows a ring-shaped magnet which is made of self-recoverable segments of so-called “parallel orientation” and which has two pole pairs. That is to say, the pole center (the angle M_{θ1}) in FIG. 9 corresponds to 90 degrees in FIG. 8A.

On the other hand, referring to FIG. 9, an angle formed between a C-axis and a circumferential tangent line at the pole end is 45 degrees. However, magnetization does not occur at right angles between the opposite poles, wherein by static magnetic interaction, the anisotropy distribution between the opposite poles becomes substantially equal to the distribution of the magnetization vector angle obtained by an isotropic Nd₂Fe₁₄B bonded magnet prepared as a comparison example shown in FIG. 8A which is sinusoidally magnetized and which has a (BH)ₘₐₓ of 80 kJ/m³. Also, the integration value of the surface magnetic flux density φs relative to the mechanical angle φ (refer to FIG. 8B) is proportional to the sum of the magnetic flux. The integration value ratio between the invention example and the above mentioned comparison example (isotropic Nd₂Fe₁₄B bonded magnet) was 1.44. The value can be approximated by the square root of the ratio of the (BH)ₘₐₓ if the magnetic circuit is structured identically. This evidences that the ring-shaped magnet according to the present invention can be made of self-recoverable segments without deteriorating the degree of anisotropy of a (BH)ₘₐₓ of 167 kJ/m³ shown in FIG. 58.

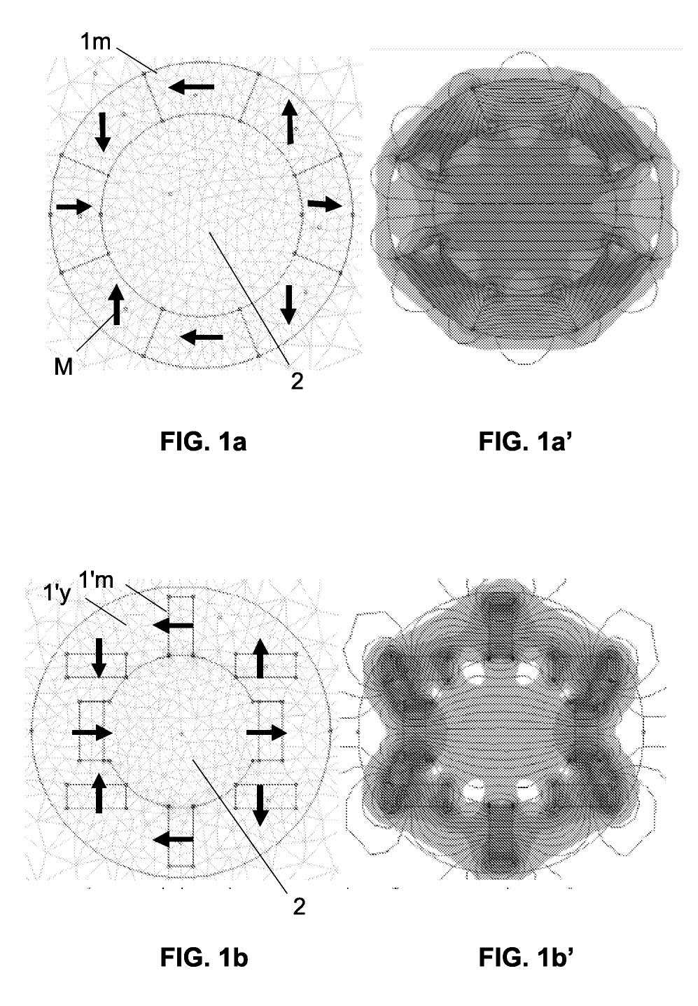

It is self-explanatory that the Halbach array made of eight segments as shown in FIG. 1A can also be easily achieved only by arbitrarily changing the direction of the external magnetic field Hex and the orientation of the self-recoverable segment Seg. 61 according to the present invention in FIG. 6A. In addition, there is no problem at all if the cross sectional shape of the self-recoverable segment according to the present invention is optimized as needed by using a known method, for example, such that the radial-direction thickness of the self-recoverable segments Seg. 61-1 and Seg. 61-4 is made uneven thus making the outline as indicated by a broken line in FIG. 9 (Y. Pang, Z. Q. Zhu, S. Ruangsinchaiwanich, D. Howe, “Comparison of brushless motors having Halbach magnetized magnets and shaped parallel magnetized magnets”, Proc. of the 18th Int. Workshop on HPMA, PP. 400-407 (2004)) for the purpose of reducing the torque pulsation attributable to the permeance variation associated with the rotation of an electromagnetic drive unit like a rotary machine.

<Anisotropy direction control of self-recoverable segments> Description will now be made, with reference to an example, about an anisotropy direction control which is performed utilizing the self-recovery function as a principle that operates such that the fracture surface formation and the viscous deformation are caused due to the heat and the external force while the inner and outer circumferential surfaces of the self-recoverable segment according to the present invention are constrained as shown in FIGS. 3A, 3B and 3C, whereby only the direction of anisotropy is changed without deteriorating the degree of anisotropy.

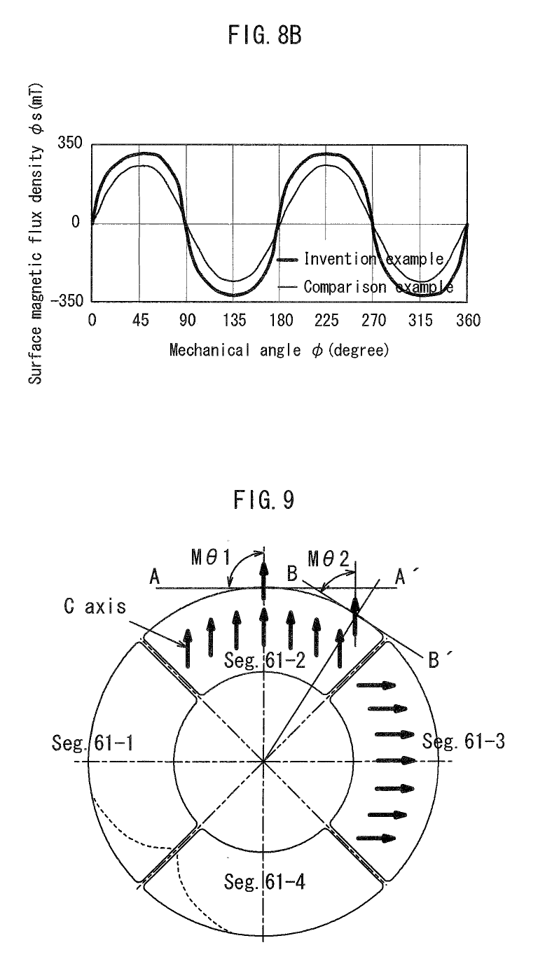

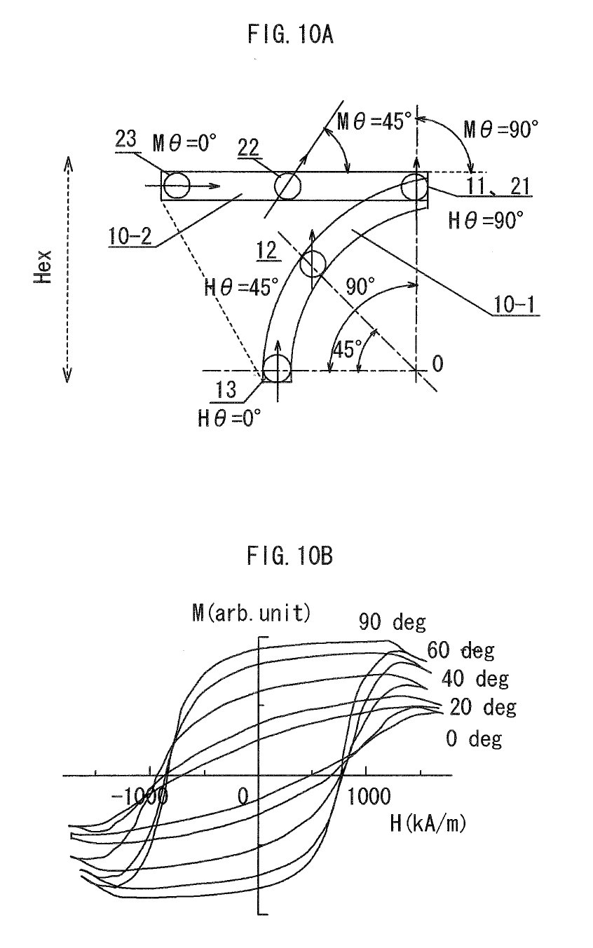

Referring to FIG. 10A, 10-1 refers to a bowed self-recoverable segment shown in cross section according to the present example which is yet to be subjected to deformation and has an outer radius of 30.0 mm and an inner radius of 27.5 mm on origin O, and 10-2 refers to a plate-like segment shown in cross section which is processed such that the self-recoverable segment 10-1 is heated to 150° C. and turned into a gel state, and that the segment 10-1 gelated is extruded to be positioned as indicated by 10-2 under a pressure of 10 MPa or less using a punch made of silicone vulcanized rubber while the outer and inner circumferential surfaces of the segment 10-1 are constrained, and then is re-compacted without retention time. In this connection, the self-recoverable segment which is gelated at the extrusion process turns into an amorphous piece but is aggregated by re-compacting process and rigidified together by self-recovery of the fractured surface. Also, in FIG. 10A, H_{θ} refers to an angle formed between a tangent line to the outer circumference of the gelated self-recoverable segment 10-1 and the external magnetic field Hex, 11, 12 and 13 refer to circular cylindrical samples cut out from respective portions of the gelated self-recoverable segment 10-1 and having a diameter of 1 mm, and 21, 22 and 23 refer to circular cylindrical samples cut out from respective portions of the plate-like segment 10-2 and having a diameter of 1 mm. The samples 21, 22 and 23 are located to correspond to the samples 11, 12 and 23, respectively. An, angle M_{θ} refers to an angle formed between an outer circumferential tangent line (which corresponds to the surface of the segment in the case of the plate-like segment deformed) and the C-axis, that is the direction of anisotropy.

In FIG. 10A, when the center position of the samples 11, 12 and 13, and the center position of the samples 21, 22 and 23 were defined as H_{θ} and M_{θ} respectively, with respect to the origin O, angles at which the maximum magnetization Mₘₐₓ was the largest with respect to all the directions as in the sample 21 as shown in FIG. 10B were calculated, that is to say, the H_{θ} and M_{θ} of each sample were calculated. The result came out that the differences of the maximum magnetization Mₘₐₓ between the samples 21 and 22, between the samples 12 and 22, and between the samples 13 and 23 were 0.03 T or less.

On the other hand, the degree of anisotropy was evaluated in terms of anisotropy dispersion δ. The anisotropy dispersion δ, or the anisotropy (C-axis) distribution of aligned rare-earth iron-based magnetic powders, was analyzed in such a manner that in an expression: a total energy E in rotational magnetization=Ku·sin²λ−Ms·H·cos(λ−λo), firstly, λ was determined by the solution that minimizes the total energy E of the circular cylindrical magnet, that is: (δE/δλ)=Ku·sin²λ−Ms·H·sin(λ−λo)=0, then M—H loop that maximizes M was measured from an expression: M=Ms cos(λo−λ) by a vibrating sample magnetometer (VSM), and further that X was found from: Ku·sin²λ−Ms·H·sin(λo−λ)=0, and the entire orientation state, that is the anisotropy dispersion δ, was found by applying the probability distribution of λ. In the above expressions, λo is an angle of the external magnetic field, λ is an angle of the rotation of Ms, Ms is a spontaneous magnetic moment, Ku is a magnetic anisotropy constant, and E is a total energy. The analysis shows that the angles at which the magnetization Ms is the largest with respect to all the directions in the samples 11, 12 and 13, and the samples 21, 22 and 23 (the angles are, namely, the H_{θ} and the M_{θ}) are substantially equal to each other as shown in Table 1, wherein the largest of the differences in the anisotropy dispersion 6 respectively between the samples 11, 12 and 13 and the samples 21, 22 and 23 located corresponding respectively to the samples 11, 12 and 13 is seen between the samples 13 and 23, that is when the direction of the anisotropy was controlled from the plane perpendicular direction to the in-plane direction, but the largest difference is less than 7%. The difference can be treated as an equivalent level in consideration of measurement deviation, and accordingly it is indicated that the direction of anisotropy can be duly controlled by taking advantage of the self-recovery function which is generated such that the fracture surface formation and the viscous deformation are caused due to the heat and the external force while the inner and outer circumferential surfaces of the gelated self-recoverable segment according to the present invention are constrained and which works so that only the direction of anisotropy is changed without deteriorating the degree of anisotropy thereby.

TABLE 1

| Sample | Hθ or Mθ | Anisotropy dispersion δ | Difference of δ (%) |
|---|---|---|---|
| 11 | Hθ 90 | 15.68 | |
| 21 | Mθ 90 | 15.41 | 1.72 |
| 12 | Hθ 45 | 17.37 | |
| 22 | Mθ 45 | 17.58 | −1.21 |
| 13 | Hθ 0 | 12.90 | |
| 23 | Mθ 0 | 13.79 | −6.90 |

What is claimed is:

1. A rare-earth iron-based magnet with self-recoverability, comprising a plurality of segments, wherein the segments each include a matrix having a microstructure in which rare-earth iron-based aligned magnetic powders of at least one kind are solidified by a cross-linking reaction phase and also in which the cross-liking reaction phase and a viscous deformation phase resulting from on a slip flow are chemically bound to each other between the magnetic powders, and wherein while inner and outer circumferential surfaces of the segments are constrained, fracture surfaces of the segments, and also the segments on a needed-basis, are mutually aggregated and rigidified together by taking advantage of self-recovery function based on viscous deformation caused by heat and external force as well as on cross-linking reaction.

2. A rare-earth iron-based magnet with self-recoverability according to claim 1, wherein the rare-earth iron-based magnetic powders of at least one kind have a (BH)ₘₐₓ of 250 kJ/m³ or more and a volume fraction of 80 vol. % or more.

3. A rare-earth iron-based magnet with self-recoverability according to claim 1, wherein the rare-earth iron-based magnetic powders, the cross-linking phase and the viscous deformation phase account in total for 97 vol. % or more, and voids account for 3 vol. % or less in terms of volume fraction.

4. A rare-earth iron-based magnet with self-recoverability according to claim 1, wherein a difference in maximum magnetization Mₘₐₓ between the segment and a magnet corresponding to the segment is 0.03 T or less, and a difference in anisotropy dispersion δ therebetween is 7% or less.

5. A rare-earth iron-based magnet with self-recoverability according to claim 1, wherein the rare-earth iron-based magnet has a remanence Mr of 0.95 T or more, a coercivity (HcJ) of 0.95 MA/m or more and a (BH)ₘₐₓ of 160 kJ/m³.

6. A rare-earth iron-based magnet with self-recoverability according to claim 1, wherein the rare-earth iron-based magnet has a shape of one of arc and circular cylinder, comprises at least one pole pair, has a permeance coefficient Pc of 3 or more and constitutes a magnetic circuit together with an iron core.
